(19) United States
(12) Patent Application Publication
(10) Pub. No.: US 2005/0017446 A1
(43) Pub. Date: Jan. 27, 2005

(54) Lottery and games of forecasting parameters

(76) Inventor: Ami Hasson, Rishon LeZion (IL)

Correspondence Address: ROBERT L STONE PC, 13 MEADOWLARK LN, EAST BRUNSWICK, NJ, 08816, US

(21) Appl. No.: 10/623,455

(22) Filed: Jul. 21, 2003

(51) Int. Cl. A63B 71/00

(52) U.S. Cl. 273/138.1

(57) ABSTRACT

A forecasting game, wherein the participants select from selectable options of the state of a real-life parameter, as being a forecast of the actual state of the real-life parameter on a determining date. The forecasting game includes a participation form having the selectable options of the parameter state. The parameter may be a meteorological or an economical parameter. The winning participation form contains the actual state of the parameter on the determining date.

### FIELD OF THE INVENTION

The present invention relates to lotteries, in general, and, in particular, to forecasting games wherein a participant may win by predicting future data.

### BACKGROUND OF THE INVENTION

Lotteries have long been known in the art. These include the well-known loto games, wherein the participants purchase a lottery card and choose, or allow a machine to randomly choose for them, certain numbers of a given series of numbers. The prize winning series of numbers are randomly drawn by a machine. There are also known wagering games wherein the participants try to predict the outcomes of soccer games or horse races which take place on a certain date. The participant or participants who guess the end results of such sporting events win the prize or prizes.

Although predicting outcomes of real life sporting events have been used in various forecasting games, such games have not been used to forecast meteorological parameters' data or economical parameters' data at a predetermined date and time in the future.

### SUMMARY OF THE INVENTION

The present invention provides a forecasting game including selectable options of real life parameter state data at a pre-selected instant in the future to be chosen by each participant.

According to one embodiment, the forecasting game includes a markable participation form including signs representing each selectable option of data. The forecasting game form may be an electronic form.

According to one preferred embodiment of the invention, the real life parameter may be a meteorological parameter.

According to another preferred embodiment, the real life parameter may be an economical parameter.

### BRIEF DESCRIPTION OF THE DRAWINGS

The present invention will be further understood and appreciated from the following detailed description taken in conjunction with the drawings in which:

FIG. 1 is an example of a forecasting game form for use in a forecasting game according to one embodiment of the present invention; and

FIG. 2 is an example of a forecasting game form for use in a forecasting game according to an alternative embodiment of the present invention.

### DETAILED DESCRIPTION OF THE INVENTION

The present invention deals with forecasting games based on “studied” data, preferably in two main areas: meteorology and economy. “Studied” data means data indicating the state of a real life measurable or calculable parameters which have occurred prior to the forecasting game registration termination date and which can be acquired from public sources, or subject matter the participants can learn about, so as to make an educated prediction. Meteorological and economy related forecasting games, unlike numbers related lotteries, could be of interest in a specific field, and could help the participant to accumulate some useful information on which to base their forecast.

The date of the forecasting game, including the time, shall be hereinafter referred to as “The Determining Date”. The determining date is set in advance, a few days after the forecasting game registration termination date, hereinafter referred to as “The Termination Date” Naturally, the data known on the termination date will be different from the data measured or calculated on the determining date. The formal data made public on the determining date serve as the forecasting game results (subject to its terms).

The novel forecasting game can be a local, national or international game. Preferably, the forecasting game according to the present invention would be open to any person who registered and paid his dues, subject to the forecasting game conditions and the forecasting game operator's Code.

The forecasting game operator could be a commercial company, or an organization holding a franchise from the local or national government, or another body, provided that there is no legal hindrance preventing it from operating the forecasting game in that jurisdiction. The said body or organization shall be hereinafter referred to as “The Forecasting Game Operator”. The entire forecasting game, its commencement date, its scope and adjustment, shall be set by the forecasting game operator or the nominating body, as they shall deem fit. (A nominating body may be a government agency to authorize the forecasting game operator). It is recommended that the forecasting game operator shall carry a suitable insurance, purchased from a major bank/insurance concern, to secure the rights of the winners.

The forecasting game operator provides the forecasting game participants with participation forms; it carries out initiated forecasting game advertisement (either directly or through its representatives), inputs the forecasting game forms in its computer, examines the results and pays the winners. It will be appreciated that the forecasting game participation forms can be electronic forms, i.e. virtual forms stored in computers and provided to participants through an internet web site, for example.

The forecasting game operator's profits shall be set according to local regulations, and they shall be invested as the forecasting game operator or the legal nominating body shall deem fit.

As mentioned above, the forecasting game, which is the invention subject matter, preferably deals with either meteorology or economy parameters' state data. For example, a meteorology forecasting game could be a forecasting game based on the temperature measured on the determining date in cities or other locations in a certain country and/or around the world. Alternatively, the forecasting game can relate to humidity data, barometric pressure data, wave altitude and/or wind velocity and/or other weather related parameters. It will be appreciated that those skilled in the art, that the forecasting game can relate to one or more such meteorological parameters. A forecasting game model dealing with the temperature in cities and various locations around the world at a pre-selected date and time is described in detail below.

An example of an economy forecasting game is a forecasting game related to rates of stocks or bonds in stock exchanges around the world, e.g. percentage change or absolute rates, local or international market share rates, overall index value of one or more stock exchanges around the world, currency fluctuations, such as the English Pound, the Japanese Yen, the Swiss Frank, the Swedish/Danish Krone, the Australian/Canadian Dollar—relative to the Dollar or the Euro or any other currency, inflation indices in one or more countries around the world, calculated at a pre-selected date and time during the determining date. Forecasting games can also be held on various other economical parameters.

According to the present invention, a certain period of time may elapse from the registration commencement date for a given forecasting game, until registration is completed and closed. The determining date may be set in advance, allowing several days between the termination date and the determining date itself, e.g. the registration to forecasting game No. 100 may be open on May 1, 2004. The registration to the above forecasting game may be closed on May 10, 2004, i.e.—the termination date. The forecasting game may be held on May 20, 2004, i.e.—the determining date.

As mentioned, the invention will be demonstrated through a detailed example of a meteorological forecasting game utilizing temperature data in various places around the world, and through an example of an economic forecasting game.

### EXAMPLE I

### Temperature Related Forecasting Game

(A) The forecasting game operator shall enter into detailed agreements with professional (public or private) bodies, for providing meteorological measurements data. The forecasting game operator shall receive from these bodies the temperature data (in Fahrenheit or Celsius), as shall be separately measured on the determining date (which includes the date and time at which the temperature was measured). The formal data received on the determining date from the professional bodies may not be contested.

(B) Prior to the commencement of the forecasting game, an advertisement campaign shall take place in each target country, to publicize all the forecasting game details. Potential participants may review the forecasting game conditions and/or Code, and their taking part in the forecasting game shall constitute the participant's approval and consent to the conditions and the Code.

It is important to remember that the specific data received from the forecasting game participants may be held in the forecasting game operator's computers. These data and not the forecasting game forms, either physical or electronic kept by the participant, may serve as the determining factor pertaining to prizes.

(C) The forecasting game participation forms shall be distributed by agents and sub-agents in each relevant country, and/or by an online system, through the company's site and/or local backup sites.

(D) The forecasting game may be based on temperature measurements in cities or other locations around the world, or in the relevant country—provided that a binding temperature is measured in that location on a pre-selected date and time (the determining date), by a meteorological institute, for example.

The forecasting game could be held on a daily, weekly, monthly and so on, basis as shall be deemed fit by the forecasting game operator. (Needless to say, that the forecasting game shall be carried out only where no legal hindrance exists, according to local laws, prohibiting the forecasting game from taking place).

(E) The forecasting game may be held with regard to meteorological data from several predetermined cities/locations, the actual number of which shall be determined by the forecasting game operators as they may deem fit, provided that in all cities or locations, the temperature or other selected meteorological parameter is accurately measured, on the determining date.

(F) The forecasting game shall refer to Celsius or Fahrenheit degrees, as shall be set by the forecasting game operators, and as customary in the countries where the forecasting game is held. Conversion tables or any other indication shall be provided, for the participants' convenience.

Preferably, the measured temperature degrees shall be rounded off by the forecasting game operators to whole numbers upward or downward (in case of 21.5°, for example, it may be rounded of to 22°. In case of 21.4°, it may be rounded off to 21°, etc.).

Below are three possible forecasting game participation options. The options may be combined or changed according to place and technology availability.

Option 1—Issuance of a Physical Participation Form at the Forecasting Game Outlet:

Draft participation forms will be distributed free of charge in all the forecasting game outlets. Each participant shall complete a draft participation form. The participant shall hand over the completed participation form to the counter tender, and pay a fee for participating in the forecasting game. The counter tender shall enter the participation form into a machine, for reading the data marked by the participant, and the personal details of the participant. The machine shall produce an original forecasting game form, a copy of which is stored in the computer. The original forecasting game form issued to the participant shall carry a unique number and/or barcode and/or other absolute and unique, one-time identification means.

The participant may cancel his participation on the spot, if the original forecasting game form is not identical with the draft participation form. (It should be emphasized that an original forecasting game form may be canceled, and a new one produced only at the time of forecasting game registration, and not later on).

In any case, the data marked by the participants on the participation forms and entered into the forecasting game operator's computer—i.e., by the forecasting game operator or his authorized representative—are the data to take part in the forecasting game, and the participants agree in advance with the same.

The original forecasting game forms are kept in the forecasting game operator's computerized data base. After the determining date, the forecasting game operator scans the forms to collect the selected options, and compare the selected options with the measured actual temperature to determine whether the temperatures indicated on any of the original forms are the same as the measured temperatures on the determining date. If so, the operator locates the winners and distributes the prizes.

Option 2—Internet—On-Line Participation

The forecasting game operator may maintain an international Internet site, preferably operating in other languages, in addition to English, according to the forecasting game deployment areas. A support site may also be opened in every country hosting a forecasting game. The site shall provide all the forecasting game details, including the Code/lottery rules, possible prices and the like and an electronic lottery form.

Preferably, the lottery participant shall complete mandatory particulars on an electronic form, i.e. a virtual form appearing on a web site for remote insertion of data, containing his or her personal details, such as the following: full name and address, identity number, user name, password—including repeated entry of the password, to avoid errors, and a statement that he has attained a certain age.

Preferably, the system will guide the user, through a separate short film, as to the electronic forecasting game form completion mode, to avoid errors. In repeated participation by the same user in forecasting games according to the present invention, only the user name and password need be entered.

The system shall route the participant's particulars to the Internet site, and shall interrupt its operation whenever encountering impossible or inaccurate details. For example—a user's name which has already been used, an inappropriate password, and so on.

The system shall check the credit card given by the participant for payment of the participation price, and shall approve the electronic forecasting game form, by allocating a unique, one-time identification means (number or another code) to the form.

The system shall be highly secured, and shall be updated versus the credit card companies, in respect of limited, blocked or expired credit cards.

After the determining date, the electronic forecasting game forms shall be examined to determine which forms accurately predicted the correct data. The winners shall receive their winnings and the site/s shall carry data of the scope of the winnings. Concurrently, the data required for a new forecasting game (including the new forecasting game registration commencement date) can also be made public in the site/s.

Option 3—Submission of an Actual Participation Form at the Point of Sale:

The participant shall receive a participation form at the forecasting game outlet, consisting of two or three copies (one copy—original, second copy—for the participant, third copy—for reasons of security).

The participant shall complete the participation form and shall add his personal particulars. He shall submit the completed form with payment of the participation price to the counter tender, who will stamp it through the machine, adding a unique number to the participation form.

The original participation form shall remain with the counter tender, and the participant shall receive the copy. The outlet shall keep all stamped forms, and shall transfer them on a set date and in a set mode by the forecasting game operators to a forecasting game center.

The forecasting game center, equipped with a computer and scanning system, shall scan the original participation forms, reading the markings of the participants, and shall computerize the data thereon.

Preferably, software is provided, during scanning, to the participation form number, using an inbuilt program. During scanning, a picture of the decoded participation form (microfilm is possible) shall be generated at the end of each file, as well as a computerized and decoded file of the participation form itself.

After the forecasting game is held, a neutral winning form containing, the correct (winning) data on the determining date, may be input into the forecasting game system. The system may examine all scanned participation forms and may locate the winning form/s. To remove any doubt, the winning form may be compared to the original participation forms or to the scanned pictures, also kept in the system. Such examination can also be accomplished manually.

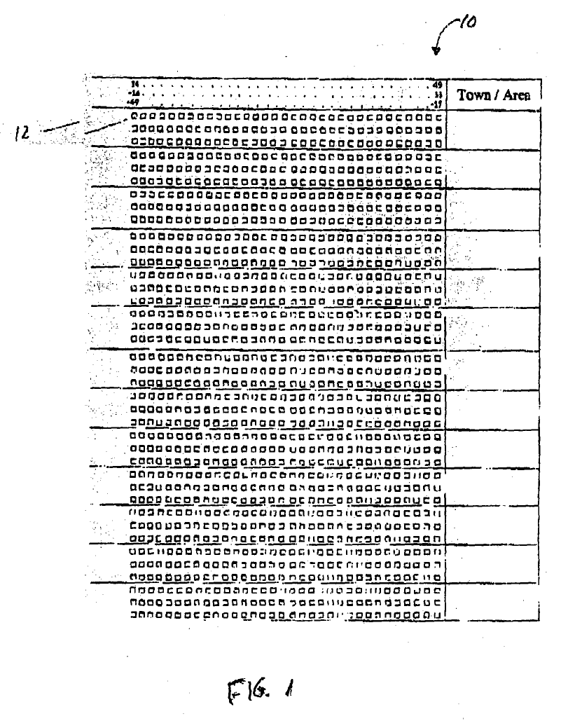

FIG. 1 shows an example of one embodiment of a possible physical participation form 10 (Form No. 1). In this embodiment, the participant selects the temperature by marking a square 12 (the square may be crossed—X, or filled). The squares could be painted dark red for high temperatures, changing their color through light blue to dark blue for the coldest temperatures.

### EXAMPLE II

### An Economy Related Forecasting Game

For the sake of demonstration: the forecasting game shall request the participants to guess the share indices closing rates, or the share indices rates at any pre-selected time of the trading, in securities stock exchanges in various locations around the world (for example—the USA, Japan, Germany, France, England, Israel, and so forth), on the determining date (to be separately set).

Please note that the stock exchange trading time, on the determining date, is different, according to the time zone. Therefore, the formal announcement of the shares indices on the determining date, by participating stock exchanges around the world, shall determine the forecasting game results.

Possibly, the forecasting game shall be held in one of the following modes:

1. Change by percentage (or points) that occurred from the registration commencement date to the forecasting game date (the determining date).

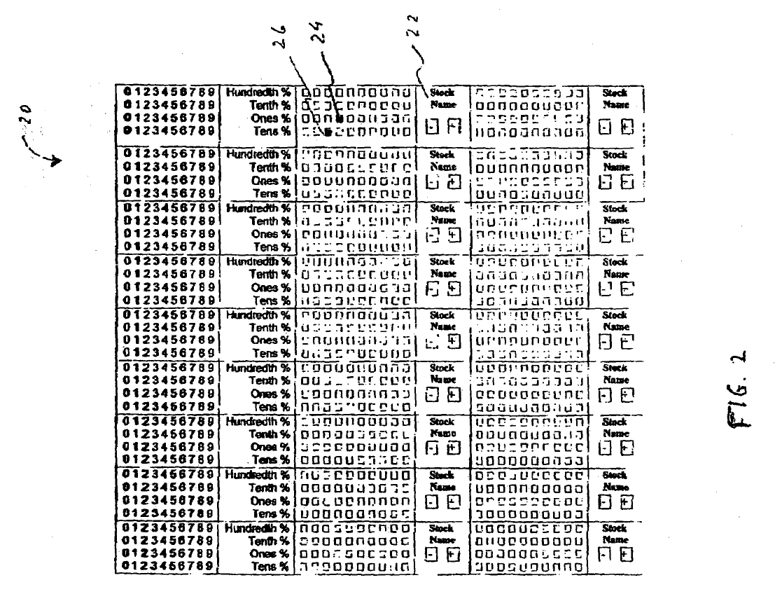

The data of the share indices rates on the forecasting game commencement date may be made public on the forecasting game operator's sites, and may be available to the participants in all outlets. The participants may indicate on the participation form illustrated by participation form 20 shown in FIG. 2 (Form No. 2) an increase or decrease in the percentage value of a stock. For example, if the participant forecasts that stock 22 will increase at the determining date and time by 3.2% he will indicate boxes 24 and 26 respectively on Form No. 2 as shown in FIG. 2. The manner of holding the forecasting game according to this example in respect of deployment, registration and control may be similar to the temperature related forecasting game.

2. Marking of actual indices points of each stock appearing on the participation form, which the participant predicts that the value of the index will be on the determining date.

3. Selecting the overall market index at the determining date in one or more stock exchanges.

Economy related forecasting game may be carried out similarly to the temperature related forecasting game.

A significant advantage of an economy related forecasting game is the fact that the data acquisition infrastructure is relatively simple and is already available; therefore, it requires lower investment in organization and in setting up the forecasting game infrastructure.

The forecasting game may be diversified by changes and modifications (for example—in a forecasting game relating to 30 certain leading shares in the world, 10 additional, different shares may be added).

It is an advantage of the invention that these forecasting games (should they become international) would help, to some extent, in turning the world into one global village, in terms of collaboration and interest. A portion of the forecasting game profits could be allocated to national projects, to positively effect the quality of life in the given country.

Preferably, the winnings of recent forecasting games may be publicized in the outlets and on the forecasting game operator's sites. It should also be indicated whether a portion of the forecasting game operator's profits are for public use, and to what projects have the funds been channeled.

It will be appreciated that the invention is not limited to what has been described hereinabove merely by way of example. Rather, the invention is limited solely by the claims which follow.

1. A forecasting game comprising selectable options of at least one real-life parameter state to be chosen by each of a plurality of participants as a forecast of the actual state of said real-life parameter on a determining date wherein said real-life parameter is selected from the group consisting of a meteorological parameter and an economic parameter.

2. The forecasting game according to claim 1, further comprising a markable participation form including signs representing each of said selectable option.

3. The forecasting game according to claim 2, wherein said format is an electronic form.

4. The forecasting game according to claim 1, wherein said real-life parameter is a meteorological parameter.

5. The forecasting game according to claim 4, wherein said meteorological parameter is selected from the group consisting of: the temperature humidity; barometric pressure; wave altitude; wind velocity; and other weather related parameters in cities or other locations in a certain country and/or around the world.

6. The forecasting game according to claim 1, wherein said real-life parameter is an economic parameter.

7. The forecasting game according to claim 6, wherein said economic parameter is selected from the group consisting of: rates of stocks or bonds in one or more stock exchanges around the world; local or international market share rates, overall index value of one or more stock exchanges around the world; currency. fluctuations relative to the Dollar or the Euro or any other currency; inflation indices in one or more countries around the world; and other economic related parameters.

8. A method of running a forecasting game, the method comprising:
providing selectable options of at least one real-life parameter state to be chosen by each of a plurality of participants as a forecast of the actual state of said real-life parameter on a determining date, wherein said real-life parameter is selected from the group consisting of a meteorological parameter and an economic parameter;
storing selectable options of a state of said real-life parameter selected by said plurality of participants;
determining the actual state of said real-life parameter on said determining date; and
comparing said stored selectable options with said actual state to determine whether any of said selected selectable options is the same as the actual state of said real-life parameter determined on said determining date.

9. The method according to claim 8, further comprising the step of distributing markable participation forms including signs representing each of said selectable options to said plurality of participants, prior to said step of storing.

10. The method according to claim 9, further comprising the step of collecting said participation forms with a participation fee from said participants after said step of distributing.

11. The method according to claim 9, wherein said step of distributing includes distributing of electronic participation forms.

12. The method according to claim 8, further comprising distributing a prize to a participant whose selected options are the same as the actual d eter mined states of the parameters

13. The method according to claim 8, wherein said at least one real-life parameter is a meteorological parameter.

14. The method according to claim 13, wherein said meteorological parameter is selected from the group consisting of: the temperature; humidity; barometric pressure data; wave altitude data; wind velocity data; and other weather related phenomena, in cities or other locations in a certain country and/or around the world.

15. The method according to claim 8, wherein said at least one real-life parameter is an economic parameter.

16. The method according to claim 15, wherein said economic parameter is selected from the group consisting of: rates of stocks or bonds in stock exchanges around the world; local or international market share rates; overall index value of one or more stock exchanges around the world; currency fluctuations relative to the Dollar or the Euro or any other currency; inflation indices in one or more countries around the world; and other economic related parameters.
